(19) United States
(12) Patent Application Publication
(10) Pub. No.: US 2016/0147372 A1
(43) Pub. Date: May 26, 2016

(54) ELECTRONIC DEVICE AND METHOD

(71) Applicant: KABUSHIKI KAISHA TOSHIBA, Tokyo (JP)

(72) Inventors: Dai OYAMA, Tokyo (JP); lsao OHBA, Tokyo (JP)

(73) Assignee: KABUSHIKI KAISHA TOSHIBA, Tokyo (JP)

(21) Appl. No.: 14/858,340

(22) Filed: Sep. 18, 2015

Related U.S. Application Data
(60) Provisional application No. 62/082,490, filed on Nov. 20, 2014.

(51) Int. Cl. G06F 3/041; G06F 1/16; G06F 3/02

(52) U.S. Cl. CPC G06F 3/0418; G06F 3/0412; G06F 3/0227; G06F 1/1694

(57) ABSTRACT

According to one embodiment, an electronic device includes a first unit, a second unit, a sensor and a processor. The first unit includes a keyboard. The second unit is rotatably attached to an end of the first unit and includes a touchscreen display. The sensor is configured to detect a positional relationship between the first unit and the second unit. The processor is configured to set a correction value for correcting a coordinate value acquired by the touchscreen display based on a detected value of the sensor.

### CROSS-REFERENCE TO RELATED APPLICATIONS

This application claims the benefit of U.S. Provisional Application No. 62/082,490, filed Nov. 20, 2014, the entire contents of which are incorporated herein by reference.

### FIELD

Embodiments described herein relate generally to an electronic device and a method.

### BACKGROUND

In recent years, a battery-powered portable electronic device such as a notebook personal computer (PC) and a tablet has become widespread. A number of electronic devices of this type are capable of data input (including instructions) by touch operations on a display screen.

Recently, an electronic device which can be used in, for example, both a notebook PC style and a tablet style has appeared. The user uses the electronic device in various environments. An electronic device of this type provides various utilization styles to conform to such various environments of the user.

For example, an electronic device capable of handwriting input on a display screen by use of a pen called a stylus is often equipped with an electromagnetic-induction-type digitizer. In the electronic device which is equipped with the digitizer and can be used in various styles, noise and a magnetic force which influence the digitizer are varied according to a utilization style and, for example, a phenomenon such as displacement of a position of a stroke displayed on the screen from a position touched by the stylus often occurs.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary illustration showing an example of an appearance of an electronic device according to an embodiment.

FIG. 2 is an exemplary diagram showing an example of a system configuration of the electronic device according to the embodiment.

FIG. 3 is an exemplary illustration showing a principle of influence of a magnetic field produced by an electronic component on a digitizer.

FIG. 4 is an exemplary illustration showing an example of displacement of a display position of a stroke on a display caused by the influence of an electric field produced by the electronic component.

FIG. 5 is an exemplary flowchart showing an example of an operation process of the electronic device according to the embodiment.

### DETAILED DESCRIPTION

Various embodiments will be described hereinafter with reference to the accompanying drawings.

In general, according to one embodiment, an electronic device comprises a first unit, a second unit, a sensor and a processor. The first unit comprises a keyboard. The second unit is rotatably attached to an end of the first unit and comprises a touchscreen display. The sensor is configured to detect a positional relationship between the first unit and the second unit. The processor is configured to set a correction value for correcting a coordinate value acquired by the touchscreen display, based on a detected value of the sensor.

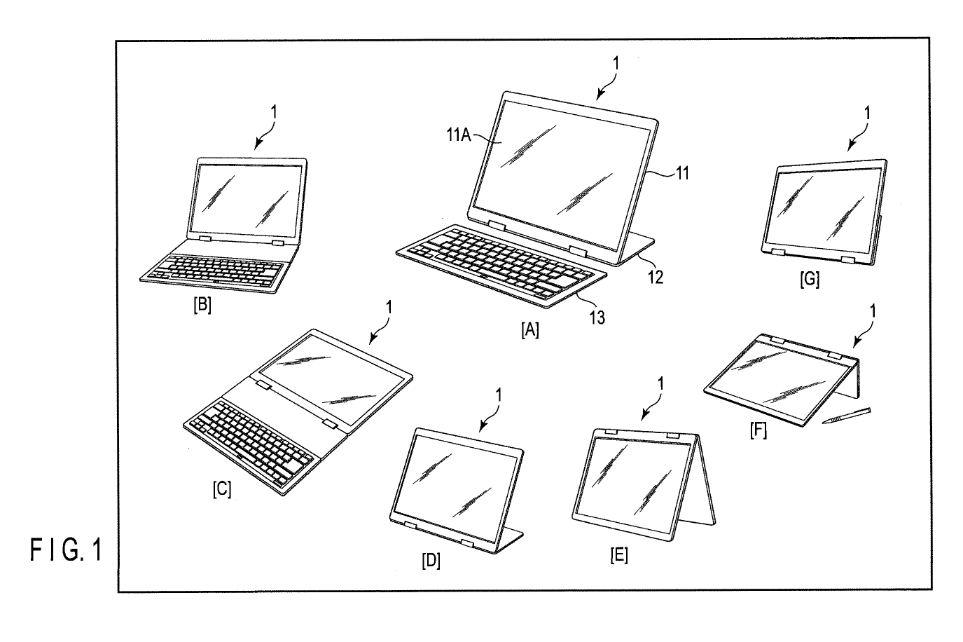

FIG. 1 is an exemplary illustration showing an example of an appearance of an electronic device 1 according to a present embodiment. As shown in FIG. 1, the electronic device 1 comprises a body 11 comprising a touchscreen display 11A, a support (stand) 12 rotatably attached to an end of the body 11, and a keyboard 13 detachably attachable to the support 12. The electronic device 1 in which the support 12 is rotatably attached to the end of the body 11 and the keyboard 13 is detachably attachable to the support 12 can provide the user with, for example, seven utilization styles as shown in FIG. 1 ([A] to [G] in FIG. 1). In other words, the electronic device 1 can be used in various styles.

The touchscreen display 11A comprises a display 112 to display an image and an electromagnetic-induction-type digitizer 105 to detect a position pointed to by a pen called a stylus. The electronic device 1 is equipped with various electronic components which produce noise and magnetic fields. The noise and magnetic force may influence the digitizer 105 and cause an error in detecting the position of the stylus. Therefore, for example, a position of a stroke displayed on the touchscreen display 11A may be displaced from a position on the touchscreen display 11A touched by the stylus. Therefore, in general, correction values for correcting the deviation are preliminarily evaluated based on the premise that the electronic device is used under certain conditions.

However, the electronic device 1 can be used in various styles as described above. If the utilization style is different, the noise and the magnetic force which influence the digitizer are also different. The electronic device 1 adaptively corrects coordinate values acquired by the digitizer 105 in accordance with a utilization style. This point is hereinafter described in detail.

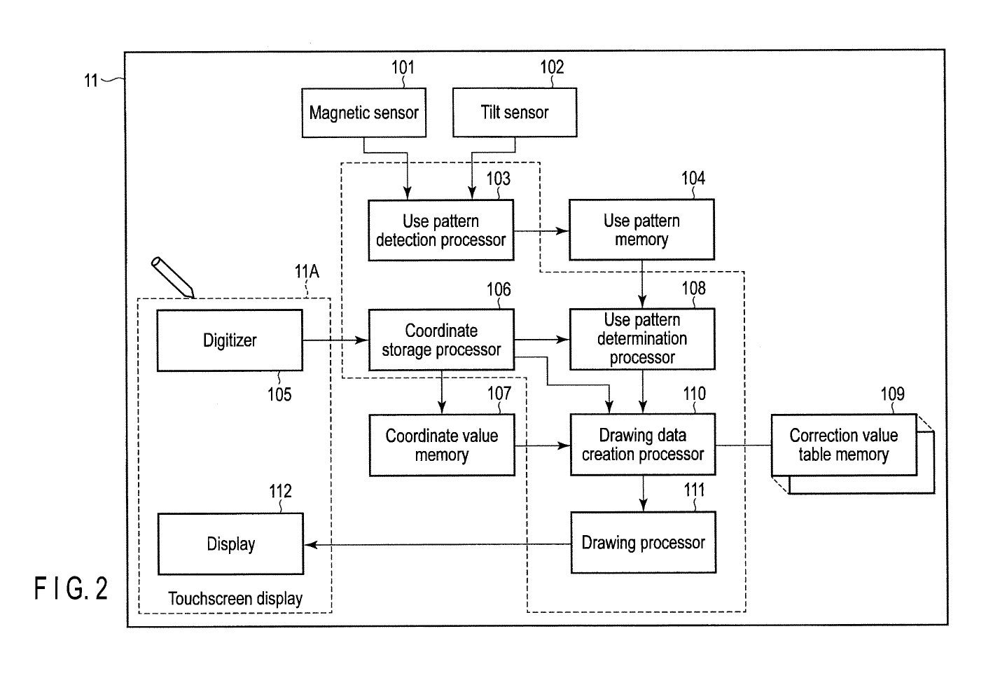

FIG. 2 is an exemplary diagram showing an example of a system configuration of the electronic device 1.

As shown in FIG. 2, the electronic device 1 comprises a magnetic sensor 101, a tilt sensor 102, a use pattern detection processor 103, a use pattern memory 104, a digitizer 105 and a coordinate storage processor 106. The electronic device 1 further comprises a coordinate value memory 107, a use pattern determination processor 108, a correction value table memory 109, a drawing data creation processor 110, a drawing processor 111 and the display 112.

A part or all of the use pattern processor 103, the coordinate storage processor 106, the use pattern determination processor 108, the drawing data creation processor 110 and the drawing processor 111 which are enclosed in dashed lines in FIG. 2 may be implemented like software by a program loaded in a main memory and executed by a processor. A part or all of these components may also be implemented like hardware by an electronic circuit (including firmware).

The use pattern memory 104, the coordinate value memory 107 and the correction value table memory 109 may be memory areas secured in the same memory medium. As described above, the digitizer 105 and the display 112 are provided in the touchscreen display 11A.

The magnetic sensor 101 and the tilt sensor 102 are sensors provided to detect in what style the electronic device 1 is used, i.e., which of the styles, for example, shown in FIG. 1 is the style of the electronic device 1. The tilt sensor 102 is, for example, a three-axis acceleration sensor. The tilt sensor 102 may be mechanically configured to detect an angle made by the touchscreen display 11A and the keyboard, i.e., an angle made by the body 11 and the support 12.

The use pattern detection processor 103 acquires detected values from the magnetic sensor 101 and the tilt sensor 102, respectively, and stores the acquired values in the use pattern memory 104. The coordinate storage processor 106 acquires a coordinate value indicating a position of the stylus on the touchscreen display 11A from the digitizer 105 and stores the acquired value in the coordinate value memory 107. The coordinate storage processor 106 notifies the use pattern determination processor 108 and the drawing data creation processor 110 that the digitizer 105 detects the stylus input.

It is assumed that the user handwrites characters on the touchscreen display 11A by the stylus. It is also assumed that the electronic device 1 displays handwritten strokes on the touchscreen display 11A in real time. That is, it is assumed that the electronic device 1 draws strokes and display the strokes on the display 112 based on coordinate values acquired from the digitizer 105. The drawing data creation processor 110 creates drawing data for indicating the strokes based on the coordinate values stored in the coordinate value memory 107. The drawing processor 111 displays the drawing data created by the drawing data creation processor 110 on the display 112.

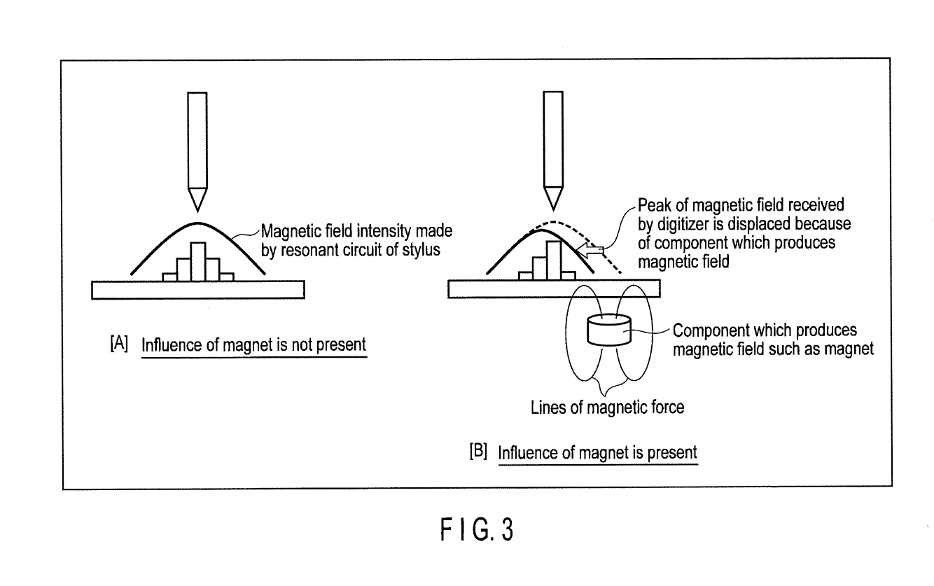

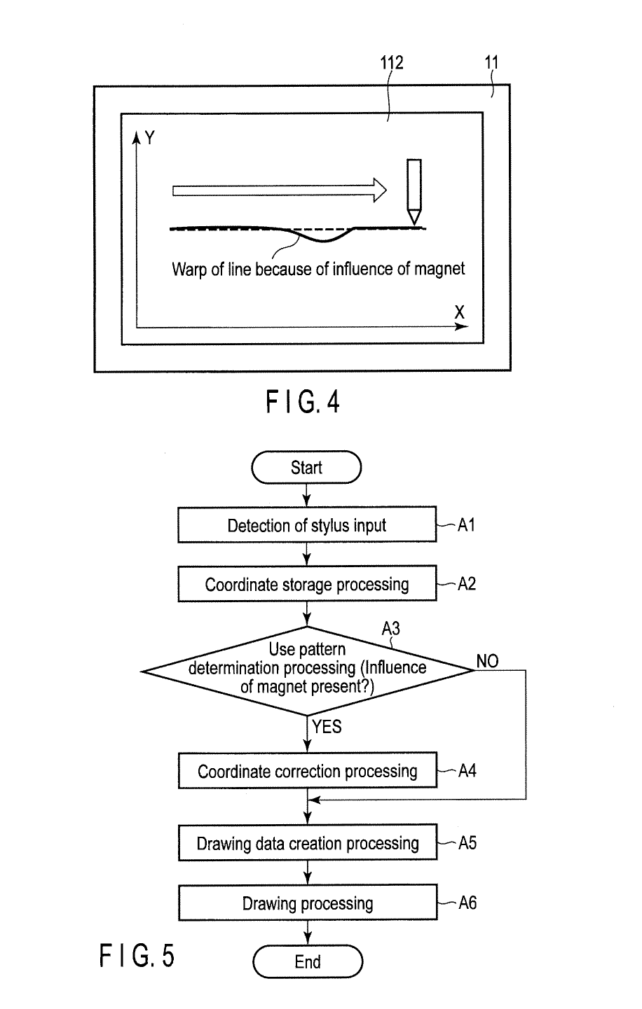

A typical example of the influence of a magnetic field produced by an electronic component on the digitizer 105 and displacement of a stroke on the display 112 due to the influence is hereinafter described with reference to FIG. 3 and FIG. 4.

In FIG. 3, [A] shows an example of a situation where the position of the stylus is detected by the digitizer 105 when the influence of a component which produces a magnetic field such as a magnet is not present, and [B] shows an example of a situation where the position of the stylus is detected by the digitizer 105 when the influence of a component which produces a magnetic field such as a magnet is present.

As shown in FIG. 3, a peak of the magnetic field intensity received by the digitizer 105 and produced by a resonant circuit of the stylus is displaced when the influence of a component which produces a magnetic field such as a magnet is present. In accordance with the displacement, the position of the stylus detected by the digitizer 105, i.e., the coordinate value becomes different from a value to be originally acquired. As a result, for example, as shown in FIG. 3, a straight line handwritten by the user by use of the stylus may be warped and displayed on the display 112.

Correction values for correcting such displacement are stored, for example, in the correction value table memory 109 in a table form for each of a plurality of sensors provided in rows and columns of the digitizer 105. More specifically, correction value tables are provided for an x-coordinate sensor and a y-coordinate sensor, respectively, and, as a result of correction according to these tables, a detected value is corrected per pixel of the display 112 provided to overlap the digitizer 105. A plurality of correction value groups stored in table form in the correction value table memory 109 may be hereinafter referred to as correction value tables. The drawing data creation processor 110 refers to the correction value tables and creates drawing data while correcting the coordinate values as necessary. For example, if a straight line or a curved line is drawn and correction is executed for one coordinate on the line, the drawing data creation processor 110 execute correction for smoothing for one or more coordinates near the one coordinate along with the correction for the one coordinate such that the correction for the one coordinate is not distinct. A linear interpolation method or a moving average method is applied to the correction of the one or more nearby coordinates. The correction value table also includes the number of steps for the correction by the moving average method.

As described above, if the utilization style is different, the noise and the magnetic force which influence the digitizer 105 are also different. Therefore, in the electronic device 1, the use pattern determination processor 108 first determines a use pattern of the electronic device 1 based on a detected value of each of the magnetic sensor 101 and the tilt sensor 102 stored in the use pattern memory 104. The use pattern determination processor 108 notifies the drawing data creation processor 110 of a result of the determination. In the electronic device 1, a plurality of correction value tables corresponding to various utilization styles, respectively, are stored in the correction value table memory 109. Each of the correction value tables includes the number of steps for the correction by the moving average method described above. That is, in the electronic device 1, the number of steps for the correction by the moving average method is dynamically varied according to the style.

The drawing data creation processor 110 selects a correction value table from the correction value tables stored in the correction value table memory 109 based on the result of the determination notified by the use pattern determination processor 108, and executes creation processing of the drawing data with reference to the selected correction value table. That is, in the electronic device 1, correction values are adaptively set according to the style. In some styles, the influence of the noise and the magnetic force on the digitizer 105 does not need to be considered.

As described above, the electronic device 1 which can be used in various styles can absorb variation of the noise and the magnetic force between utilization styles by preparing a correction value table for correcting coordinate values acquired by the digitizer 105 per style, detecting in which style the device is used, and selecting a correction value table to be referred to.

FIG. 5 is an exemplary flowchart showing an example of an operation process of the electronic device 1.

If the digitizer 105 detects stylus input (block A1), the coordinate storage processor 106 stores coordinate values acquired from the digitizer 105 in the coordinate value memory 107 (block A2). At this time, the use pattern determination processor 108 determines a current utilization style based on a detected value of each of the magnetic sensor 101 and the tilt sensor 102 stored in the use pattern memory 104 (block A3).

As a result of the determination of utilization style, if the coordinate values acquired from the digitizer 105 need to be corrected (YES in block A3), the drawing data creation processor 110 executes correction processing of the coordinate values by using a correction value table corresponding to the current utilization style of a plurality of correction value tables stored in the correction value table memory 109 (block A4). Based on the corrected coordinate values, the drawing data creation processor 110 creates drawing data (block A5), and the drawing processor 111 displays the drawing data created by the drawing data creation processor 110 on the display 112 (block A6).

If the coordinate values do not need to be corrected (NO in block A3), the drawing data creation processor 110 creates drawing data by directly using the coordinate values stored in the coordinate value memory 107 (block A5), and the drawing processor 111 displays the drawing data created by the drawing data creation processor 110 on the display 112 (block A6).

As described above, the electronic device 1 implements suitable correction of coordinate values of stylus input acquired by the digitizer 105 according to a utilization style.

In the above description, the electronic device 1 is constituted by the body 11, the support 12 and the keyboard 13. In an electronic device constituted by a body unit comprising a keyboard and a display unit comprising a touchscreen display such as a general notebook PC, for example, five utilization styles except [A] and [F] in FIG. 1 can be provided to the user. Therefore, even in an electronic device having such a structure, the method of changing a correction value table for correcting coordinates of stylus input acquired by the digitizer 105 in accordance with a utilization style is effective.

In the above description, a correction value table for correcting coordinates of stylus input acquired by the digitizer 105 is changed in accordance with a utilization style. Instead of detection of a utilization style, the type of connected keyboard 13 may be detected and a correction value table for correcting coordinates of stylus input acquired by the digitizer 105 may be changed in accordance with the detected type of keyboard 13. This method is effective especially in an electronic device having a structure which does not comprise a support 12 and can directly connect an extension unit including a keyboard to a body.

Since the operation process of each embodiment can be implemented by software (program), the same advantage as each embodiment can be easily achieved by installing the software on a general computer through a computer-readable storage medium storing the software, and executing the software.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
a first unit comprising a keyboard;
a second unit rotatably attached to an end of the first unit and comprising a touchscreen display;
a sensor configured to detect a positional relationship between the first unit and the second unit; and
a processor configured to set a correction value for correcting a coordinate value acquired by the touchscreen display, based on a detected value of the sensor.

2. The electronic device of claim 1, wherein the processor is configured to select a correction value table from a plurality of correction value tables each comprising a correction value per pixel of the touchscreen display, and to acquire a correction value from the selected correction value table.

3. The electronic device of claim 2, wherein each of the correction value tables comprises number of steps for correcting one or more second coordinate values by a moving average method along with correction of a first coordinate value when a stroke input by handwriting on the touchscreen display is displayed on the touchscreen display.

4. The electronic device of claim 1, wherein the sensor comprises a three-axis acceleration sensor.

5. The electronic device of claim 1, wherein the sensor comprises a magnetic sensor.

6. The electronic device of claim 1, wherein the sensor is configured to detect an angle made by the keyboard and the touchscreen display.

7. An electronic device comprising:
a body comprising a touchscreen display;
a sensor configured to detect an installed condition of the body; and
a processor configured to set a correction value for correcting a coordinate value acquired by the touchscreen display, based on a detected value of the sensor.

8. The electronic device of claim 7, further comprising a support which is rotatably attached to an end of the body and to which an extension unit comprising a keyboard is detachably connected,
wherein the sensor is configured to detect a positional relationship between the body and the support.

9. The electronic device of claim 7, wherein the processor is configured to select a correction value table from a plurality of correction value tables each comprising a correction value per pixel of the touchscreen display, and to acquire a correction value from the selected correction value table.

10. The electronic device of claim 9, wherein each of the correction value tables comprises number of steps for correcting one or more second coordinate values by a moving average method along with correction of a first coordinate value when a stroke input by handwriting on the touchscreen display is displayed on the touchscreen display.

11. The electronic device of claim 7, wherein the sensor comprises a three-axis acceleration sensor.

12. The electronic device of claim 7, wherein the sensor comprises a magnetic sensor.

13. The electronic device of claim 11, wherein the sensor is configured to detect a magnetic field produced by an extension unit directly or indirectly connected to the body and comprising a keyboard.

14. The electronic device of claim 7, wherein the processor is configured to set the correction value according to an extension unit directly or indirectly connected to the body and comprising the keyboard.

15. A method for an electronic device, the method comprising:
detecting an installed condition of the electronic device; and
setting a correction value for correcting a coordinate value acquired by a touchscreen display, based on a result of the detection.

16. The method of claim 15, wherein the setting the correction value comprises selecting a correction value table from a plurality of correction value tables each comprising a correction value per pixel of the touchscreen display, and acquiring a correction value from the selected correction value table.
